(19) United States
(12) Patent Application Publication
(10) Pub. No.: US 2021/0056865 A1
(43) Pub. Date: Feb. 25, 2021

(54) Purpose Initiative

(71) Applicant: Laura Frances Gates, San Rafael, CA (US)

(72) Inventor: Laura Frances Gates, San Rafael, CA (US)

(21) Appl. No.: 16/544,493

(22) Filed: Aug. 19, 2019

(51) Int. Cl. G09B 19/00

(52) U.S. Cl. CPC G09B 19/00

(57) ABSTRACT

This methodology provides a process and tools for leaders to address real-world challenges with creative world-changing solutions by changing their ways of seeing the world and thinking differently about their challenges. This process reliably creates the conditions for enhanced creativity and innovation and leads to a new way of feeling and behaving. This mythology is a tried and true method, with case studies of subjects having evolved through the process and taking the lead in their own lives while creating change in the lives of those they influence. The process integrates a variety of modalities to achieve its objectives, including self-awareness, pattern recognition and behavioral-based modalities combined with cutting edge experimentation on time management, leadership development and strategic thinking with wisdom-based tools of accessing inner knowing, mindfulness, dream recall, intuition, and visioning. Beyond theories of leadership development or management, this process requires participants to engage in real-world “disruptive” experiments designed to initiate change.

### TECHNICAL FIELD OF THE INVENTION

The present invention relates generally to a method and system for leaders to address real-world challenges with creative world-changing solutions by changing their ways of seeing the world and thinking differently about their challenges.

### BACKGROUND

One of the single biggest issues facing leaders in today's complex and rapidly changing world is responding to challenges with effective and innovative solutions. Traditional approaches use systemic, reductionist and linear approaches that fail to inspire solutions that are truly disruptive. The solutions are predictable, limited, orthodox and mainstream.

Through years of working and coaching people, the inventor began to see a pattern in the students. Many were burnt out, tired and fed up. People want to find and live their purpose, but when they are burnt out, there is no possible way for creativity to emerge. And if they get a nudge to create something, they often do not have the energy to manifest it.

The Purpose Initiative methodology is a process designed to address real-world challenges by changing our way of thinking, feeling and behaving. This method results in leaders becoming innovative and creative change agents.

This system is based on the understanding that leaders who:
Become more self-aware of their emotional (mostly unconscious) drivers, deep-seated beliefs impeding their success
Take steps to create change with “disruptive” experiments (whether managing their time, commitment to what they do with their time, how they approach certain opportunities) allowing them to change behaviors and adopt new, healthier beliefs and assumptions about themselves.

The system helps them to evolve into leaders who are more open and self-aware allowing new ideas to emerge and when acted upon, these new ideas forge innovative solutions to seemingly impossible problems.

### BRIEF SUMMARY OF THE INVENTION

‘The Purpose Initiative’ methodology reliably creates the conditions for creativity and innovation to emerge by guiding leaders through a phased-process of discovery, experimentation, and execution.

Many leaders are under the mistaken impression that certain people are creative, others are not or that creative thinking is an inherited trait. Simply providing customary solutions is no longer enough, leaders must present solutions that are both novel, creative and progressive. The concern for leaders is that conventional leadership and design approaches are not sufficient to assist leaders in developing creative solutions or inspiring originality.

When faced with the challenges of developing creative and innovative solutions, subjects often do not know where to start. This mindset often originates from preconceived ideas such as “I'm an operations/sales/marketing person, how do I become creative?” or “I do not have a creative bone in my body” or simply the belief that some have a “gift” of creativity and others do not.

There are design programs available that address the need for Self-awareness—emotional intelligence, brain-based science, behavioral based therapy, addressing patterns of behavior from childhood conditioning. Other programs address the need for harnessing time and energy as resources and finally, there are creativity and innovation programs.

Despite these various systems, however, there is no methodology that incorporates all these components (self-awareness and emotional intelligence, time and energy efficiency, creativity and innovation) successfully in a cohesive effective approach that develops creative leaders and establishes innovative thinking. Leaders who use and have used the proposed methodology outlined in the present invention, have recognized the necessity to be more creative and innovative in order to succeed and advance their goals. This system is a proven approach that develops and evolves leaders into agents of change and influence.

This system has proven that any leader can develop creative solutions to their challenges given appropriate training. The methodology outlined uses a completely new and unique approach that develops a conscious leadership system inspired by their own purpose. The system encourages individual self-awareness that inspires solutions that have a far greater impact in the wider world, beyond traditional narrow limitations.

The foundation of this methodology is based on the realization that rather than ‘trying’ to be creative or innovative, leaders who become aware of their own natural, personal emotions and thinking develop their own true innovative solutions. This methodology creates the understanding that we all have untapped creative abilities and combined with the creation of suitable conditions and space, we can allow this creativity to emerge and flourish.

The outcome is leaders who accelerate their creative/innovative processes allowing them to solve some of the most pressing and difficult challenges of our times. The methodology provides insight into how creativity can be developed instead the misconception creativity is an inherited gift. This approach is unique in that while other processes are focused on individual components of self-awareness and change, this model integrates three aspects necessary to create change:
Creating the knowledge and understanding everyone has the potential to be creative;
Creating the conditions and an environment that encourages the emergence of creativity;
Developing, exploring and acting on the innovative ideas that emerge.

### DETAILED DESCRIPTION AND BEST MODE OF IMPLEMENTATION

‘The Purpose Initiative’ is a leadership philosophy that is motivated beyond an individual's own self-interest. This leadership philosophy originates from a place of purpose inspiring us to true leadership beyond one's personal agenda or selfish concerns.

The following outlines the stages in, what is, an iterative methodology:

Stage 1: Identification and Removal of Barriers

This stage includes:
Uncovering critical insights about self-limiting triggers and blind spots
Eliminating obstacles to best thinking and leading
Making the unconscious conscious

The initial stage is exploring barriers that might prevent us from succeeding. These are the self-limiting beliefs we may have, often subconscious, that can prevent us from even going down the path of discovery in the first place. We uncover the unconscious triggers and behaviors that can derail us at the very start. We can also explore the past—for example, experiences, patterns from our childhood, events that shape our current reality in ways that limit our thinking. The goal of this phase is to make the unconscious conscious and to explore any and all obstacles that hinder our ability to progress in life.

The methodology explores the major challenge(s) the leaders want to break through. We explore fears, patterns, triggers, obsessive thoughts, addictions that get in the way of creativity and free thinking. These are thought processes that often lead us to sabotage ourselves. We explore and help the leader develop skills to manage emotional reactions and help us avoid our natural tendencies to become emotionally hijacked from established inhibitive beliefs and assumptions. It is important to understand our thoughts as these influence our emotions. In turn, our emotions influence our reactions. Under stress, our brains, naturally wired for fight or flight, prevent us from finding a state of natural creativity. We avoid stresses and mitigate reactions by becoming aware of our hot buttons and triggers. These are often typified by phrases leaders say or feel frequently: “They do not respect me”, “they do not value me”, “they do not listen to me”, “they are excluding me” or “they are ignoring me”. This process can be managed through inquiry, therapy, reading books, listening to podcasts or Ted talks, conducting a 360 feedback, journaling, and automatic writing, taking assessments such as Myers Briggs Type Indicator or EQ360 or simply taking time out to reflect. There are many paths to unearthing the ways we let fear drive our behaviors. The primary goal of this phase is to help the leader recognize their own limits.

Stage 2: Breakthrough to Creating Change

This stage includes:
Creating and navigating space
Leveraging precious resources (time & energy)
Designing disruptive experiments

This phase assists the leader in taking insights, fears, drivers, beliefs, attitudes, preconceived ideas and notions discovered in Stage 1, challenging and exploring them further inspiring change through developing self-awareness. We recognize change does not happen by simply thinking about change, change only happens when we act. Change occurs when we experiment, try new things, reinforce, explore new approaches and learn from our mistakes. This phase could also include failure. Failure is also a possible path to learning and discovery. During this phase, the subject designs their own “disruptive” experiments. These experiments are incremental stages, small, achievable actions aimed at gaining traction and allowing the leader evaluating outcomes from the experimentation, constantly exploring responses.

In this stage, we also define what we can and cannot do within the limitations of time. Many leaders who begin this work are burnt out, bored or frustrated with where they are in their lives. They are seeking change, but they fear change and they often do not know where to begin. When we help them discover ways to regain their life force energy by changing their daily routine, how they approach their day and activities or how they think about their work. As a result, they begin to feel better about their work and feel re-energized about it.

This methodology recognizes managing resources as an essential skill and therefore directly address traditional time management skills in addition to learning how to manage one's energy and emotions, as each are precious inner leadership resources. Traditional time management examines their calendar, explores how they spend their time, what leaders can let go of, what they can say ‘no’ to. What they can delegate to others, how they can bring in additional resources to manage their day to day tasks. We look at what we call their ‘Purpose Zone’—Are they operating at their optimum output? Are they focused on the right activities for the right reasons? What are ways in which they lose or waste time and energy? When we identify these energy drains, time drains or “leaks” we can then design experiments that allow the subject to create more time and space in their calendar, which in turns gives them an opportunity to have creative and insightful thoughts. We help them delegate, build more effective structures and align their time with their goals and objectives.

The present methodology develops sustainable time management skills by addressing through three routes, Time, Emotional and Energy management.

We develop leadership time management by improving personal productivity using structured toolsets of calendars, clocks and apps. The methodology develops a structure of prioritization that allows the leader to get things done and to be present when and where we are supposed to be, when we want to be there. The system ensures the leader does what they say are going to do when it is planned. The system of prioritization and effectively delegation assigns time to the tasks most important.

Through the development of emotional management leadership skills, the leaders develop a deeper personal self-awareness of triggers, hot buttons and how to navigate them. In group and private settings, the leader develops skills and tools to constructively deal with difficult issues and topics allowing constructive conflict and useful feedback. The leaders also develop an ability to recognize and profile the desires and fears of their staff, managing the need for praise, fear, failure or paralysis through fear.

Finally, developing the leader's ability to manage their energy we help them recognize who and what gives them energy, notice what drains their energy especially during key times of the day. This allows each individual to establish daily patterns to ensure sustainable practices that allow energetic work and rejuvenation. We clearly help educate the leaders on how they use sleep, exercise, meditation, music, nature, reading, silence, nutrition and other modalities to establish a functioning flow state in their Purpose Zone.

Stage 3: Making an Impact

This stage includes:
Taking courageous action
Pioneering leading edge solutions
Accessing inner wisdom

In this phase, the leader leverages their renewed energy that the subject has discovered through experimentation, learning new resource management skills (time, energy, emotions) and the space they have created.

The present methodology helps the subjects to:

1. Take courageous action.

Have the courage to do the things they say they will do, stop the excuses that until now have prevented them from moving forward in their lives and clear the path for change.

2. Pioneer leading edge solutions When we embark into new territory and step into the unknown—ideas emerge seemingly out of nowhere, assistance shows up just when we need it, we seem to be calling upon the support that until now seemed elusive. This is what it means to operate on faith and trust when we take courageous action and allow ourselves to face potential failure.
3. Finally, we access our inner wisdom.

The places where knowledge is connected with intuition, inner guidance, signs and synchronicity and the whispers of the universe. This is where true creativity and innovation emerges from the subject in ways that had not been seen or done previously.

I claim:

1. A method for creating the conditions for creativity and innovation to emerge by guiding leaders through a phased-process of discovery, experimentation, and execution.

2. The method in claim 1 wherein such method consists of three stages:
Stage 1 identifies and removes any barriers the subject may be facing;
Stage 2 is a breakthrough to create change in the subject;
Stage 3 is about the subject taking actions to make an impact.

3. The method in claim 2 wherein such method, in its first stage, helps a subject in the following:
Uncovering critical insights about self-limiting triggers and blind spots;
Eliminating obstacles to best thinking and leading;
Making the unconscious conscious.

4. The method in claim 2 wherein such method, in its second stage, helps a subject in the following:
Creating and navigating space;
Leveraging precious resources (time & energy);
Designing disruptive experiments.

5. The method in claim 2 wherein such method, in its third and final stage, helps a subject in the following:
Taking courageous action;
Pioneering leading edge solutions;
Accessing inner wisdom.
